(19) United States
(12) Patent Application Publication
(10) Pub. No.: US 2013/0285609 A1
(43) Pub. Date: Oct. 31, 2013

(54) CHARGING STATION FOR PORTABLE ELECTRONIC DEVICES

(71) Applicant: Doug Clouser, Marysville, OH (US)

(72) Inventor: Doug Clouser, Marysville, OH (US)

(21) Appl. No.: 13/657,189

(22) Filed: Oct. 22, 2012

Related U.S. Application Data
(63) Continuation-in-part of application No. 13/190,251, filed on Jul. 25, 2011.
Application No. 13/190,251 is a continuation-in-part of application No. 13/189,180, filed on Jul. 22, 2011.
(60) Provisional application No. 61/367,074, filed on Jul. 23, 2010.

(51) Int. Cl. H02J 7/00

(52) U.S. Cl. CPC H02J 7/0044
USPC 320/115

(57) ABSTRACT

A charging station for portable electronic devices includes a base having a substantially vertical and forward facing wall and at least one suction cup secured to the wall to temporarily secure the portable electronic devices to the wall in a position that the portable electronic devices can be viewed and operated while recharging. When more than one suction cup is provided they can be secured in laterally spaced-apart positions so that multiple portable electronic devices can be secured side-by-side for recharging or more than one suction cup can secure a portable electronic device. The suction cups can also be secured in vertically spaced apart positions so that the suction cup can engage the portable electronic device at a desired height or so that more than one suction cup can secure the portable electronic device. The charging station can also organize mail, keys, wallets, and the like.

### CROSS-REFERENCE TO RELATED APPLICATIONS

This application is a Continuation-In-Part of U.S. patent application Ser. No. 13/190,251 filed on Jul. 25, 2011, which is a Continuation-In-Part of U.S. patent application Ser. No. 13/189,180 filed on Jul. 22, 2011, which claims priority from U.S. Provisional Patent Application No. 61/367,074 filed on Jul. 23, 2010, the disclosures of which are expressly incorporated herein in their entireties by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to charging stations for portable electronic devices and, more particularly, to such charging stations which permit viewing and operation of the portable electronic devices during recharging.

### BACKGROUND OF THE INVENTION

Portable electronic devices such as, telephones, personal digital assistants (PDAs), digital cameras, mp3 players, tablet computers, and the like, typically utilize rechargeable batteries as a power source. The batteries are typically recharged by plugging an AC to DC power converter into the portable electronic device and into an AC power wall receptacle or outlet. The AC to DC power converter converts 110 or 120 volt AC power from the wall outlet to low voltage DC power used to charge the batteries.

With the increase in the number of available portable electronic devices, consumers can find themselves with an unpleasant and unsightly tangle of wires, cords, and/or cables for the devices. This is because each of the devices can require a different type of AC to DC converter. In addition to the unsightly appearance, the tangled wires can be unsafe because kinked wires are more susceptible to failure and because it is difficult to identify a particular cable when it is intertwined with other cables.

This problem has led to the introduction of battery charging stations that provide a mechanism for recharging the batteries of multiple personal electronic devices. Such stations can be convenient and useful for eliminating the tangle of wires. However, such stations are inadequate in that they make it difficult to view and/or use the personal electronic devices while recharging and/or are not multifunctional. Accordingly, there is a need for an improved charging station that improves visibility and usability of the personal electronic devices during charging and/or organizes and holds other objects that do not need to be charged such as mail, keys, wallets and the like.

### SUMMARY OF THE INVENTION

Disclosed are charging stations which address one or more issues of the related art. Disclosed is a charging station for a portable electronic device, said charging station comprising, in combination, a base having a substantially vertical and forward facing wall and at least one forward facing fastener on the forward facing wall so that the fastener can temporarily secure the portable electronic device to the forward facing wall in a position that the portable electronic device can be viewed and operated while recharging. The base has an attachment cover plate for securing the base directly to a wall electrical receptacle. The attachment cover plate includes at least one outlet opening and at least one fastener opening.

Also disclosed is a charging station for a portable electronic device, said charging station comprising, in combination, a base having a substantially vertical and forward facing wall and at least one forward facing fastener on the forward facing wall so that the fastener can temporarily secure the portable electronic device to the forward facing wall in a position that the portable electronic device can be viewed and operated while recharging. The base has a rear wall with a clamping opening for a wall electrical receptacle therein. An attachment cover plate is attached directly to the wall electrical receptacle to clamp the rear wall between the attachment cover plate and the wall electrical receptacle. The attachment cover plate and the body are formed as separate components and the attachment cover plate includes at least one outlet opening and at least one fastener opening.

Also disclosed is a charging station for a portable electronic device, said charging station comprising, in combination, a base having a substantially vertical and forward facing wall and at least one forward facing fastener on the forward facing wall so that the fastener can temporarily secure the portable electronic device to the forward facing wall in a position that the portable electronic device can be viewed and operated while recharging. The body forms a hollow interior and the body includes front and rear portions hinged together so that the front portion is pivotable relative to the rear portion between a closed position and an open position.

From the foregoing disclosure and the following more detailed description of various preferred embodiments it will be apparent to those skilled in the art that the present invention provides a significant advance in the technology and art of charging stations. Particularly significant in this regard is the potential the invention affords for providing a relatively low cost, versatile, and easy to use charging station which improves usability of the personal electronic devices during charging and organizes and also holds other objects that do not need to be charged. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is a front perspective view of a charging station for portable electronic devices according to a first embodiment of the present invention.

FIG. 2 is a section view of the charging station of FIG. 1.

FIG. 3 is a rear perspective view of the charging station of FIGS. 1 and 2.

FIG. 4 is a partially exploded front perspective view of the charging station of FIGS. 1 to 3.

FIG. 5 is a sectional view similar to FIG. 2 but with an outlet or wall-plug style surge protector removed for clarity.

FIG. 6 is a fragmented top plan view showing the left end of the charging station of FIGS. 1 to 5.

FIG. 7 is rear perspective view similar to FIG. 3 but with the wall-plug style surge protector removed for clarity.

FIG. 8 is a perspective view a variation of the charging station of FIG. 7.

FIG. 9 is a front perspective view similar to FIG. 1 but with a rear cover added for use in a desktop application.

FIG. 10 is a section view similar FIG. 2 but with the rear cover of FIG. 9.

FIG. 11 is a rear perspective view similar FIG. 3 but with the rear cover of FIGS. 9 and 10.

FIG. 12 is a partially exploded front perspective view similar FIG. 4 but with the rear cover of FIGS. 9 to 11.

FIG. 13 is a front perspective view of a charging station for portable electronic devices according to a second embodiment of the present invention.

FIG. 14 is a is a front perspective view of a charging station for portable electronic devices according to a third embodiment of the present invention.

FIG. 15 is a is a front perspective view of a charging station for portable electronic devices according to a fourth embodiment of the present invention.

FIG. 16 is a front perspective view of a charging station for portable electronic devices according to a fifth embodiment of the present invention.

FIG. 17 is a front perspective view similar to FIG. 9 but with bottom supports for the portable electronic devices.

FIG. 18 is a section view similar FIG. 10 but with the bottom supports of FIG. 17.

FIG. 19 is a rear perspective view similar FIG. 11 but with additional mounting openings.

FIG. 20 is a partially exploded front perspective view similar FIG. 12 but with the bottom supports of FIGS. 17 and 18.

FIG. 21 a front perspective view of a charging station for portable electronic devices according to a sixth embodiment of the present invention, with components removed for clarity.

FIG. 22 is a rear perspective view of the charging station of FIG. 21,

FIG. 23 is a rear elevational view of the charging station of FIGS. 21 and 22.

FIG. 24 is a front elevational view of a plastic sleeve for a portable electronic device which provides a planar attachment surface for use with the charging stations of FIGS. 1 to 23.

FIG. 25 is a bottom plan view of the sleeve of FIG. 24.

FIG. 26 is a left side elevational view of the sleeve of FIGS. 24 and 25.

FIG. 27 is a rear elevational view of a sleeve for a portable electronic device which has a plastic puck planar which provides an attachment surface for use with the charging stations of FIGS. 1 to 23.

FIG. 28 is a right side elevational view of the sleeve of FIG. 27.

FIG. 29 is a rear elevational view of a sleeve for a portable electronic device which has an alternative fastener in the form of a flanged pin or peg for use with the charging stations of FIGS. 1 to 23.

FIG. 30 is a right side elevational view of the sleeve of FIG. 29.

FIG. 31 is a perspective view a variation of the charging station of FIGS. 1 to 7 wherein the wall-style surge protector is replaced with a strip-style surge, protector.

FIG. 32 is a section view of the charging station of FIG. 31.

FIG. 33 is a rear perspective view of the charging station of FIGS. 31 and 32.

FIG. 34 is a partially exploded front perspective view of the charging station of FIGS. 31 to 33.

FIG. 35 is a front perspective view of a charging station for portable electronic devices according to a seventh embodiment of the present invention.

FIG. 36 is a top plan view of the charging station of FIG. 35.

FIG. 37 is an enlarged fragmented view taken along line 37 in FIG. 36.

FIG. 38 is a front elevational view of the charging station of FIGS. 35 to 37.

FIG. 39 is a cross-sectional view taken along line 39-39 in FIG. 38.

FIG. 40 is an enlarged fragmented view taken along line 40 in FIG. 41.

FIG. 41 is a rear perspective view of the charging station of FIGS. 35 to 40.

FIG. 42 is a front perspective view of a charging station for portable electronic devices according to an eighth embodiment of the present invention, wherein the charging station is attached to an electrical outlet or receptacle.

FIG. 43 is a rear perspective view of the charging station of FIG. 42.

FIG. 44 is a front elevational view of a standard Type B North American 3-pin electrical outlet or receptacle.

FIG. 45 is a front perspective view a variation of the charging station of FIGS. 42 and 43, wherein the charging station is attached to a North American GFCI electrical outlet or receptacle.

FIG. 46 is a rear perspective view of the charging station of FIG. 45.

FIG. 47 is a front elevational view of a standard North American GFCI electrical outlet or receptacle.

FIG. 48 is a front perspective view of a charging station for portable electronic devices according to a ninth embodiment of the present invention, wherein the base has a rear portion to be secured to an electrical outlet or receptacle and a front portion that removably covers the rear portion.

FIG. 49 is another front perspective view of the charging station of FIG. 48.

It should be understood that the appended drawings are not necessarily to scale, presenting a somewhat simplified representation of various preferred features illustrative of the basic principles of the invention. The specific design features of the charging stations as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the charging stations illustrated in the drawings. In general, up or upward generally refers to an upward direction within the plane of the paper in FIG. 2 and down or downward generally refers to a downward direction within the plane of the paper in FIG. 2. Also in general, front or forward generally refers to a leftward direction within the plane of the paper in FIG. 2 and rear or rearward generally refers to a rightward direction within the plane of the paper in FIG. 2.

### DETAILED DESCRIPTION OF CERTAIN PREFERRED EMBODIMENTS

It will be apparent to those skilled in the art, that is, to those who have knowledge or experience in this area of technology, that many uses and design variations are possible for the charging stations disclosed herein. The following detailed discussion of various alternative and preferred embodiments will illustrate the general principles of the invention. Other embodiments suitable for other applications will be apparent to those skilled in the art given the benefit of this disclosure.

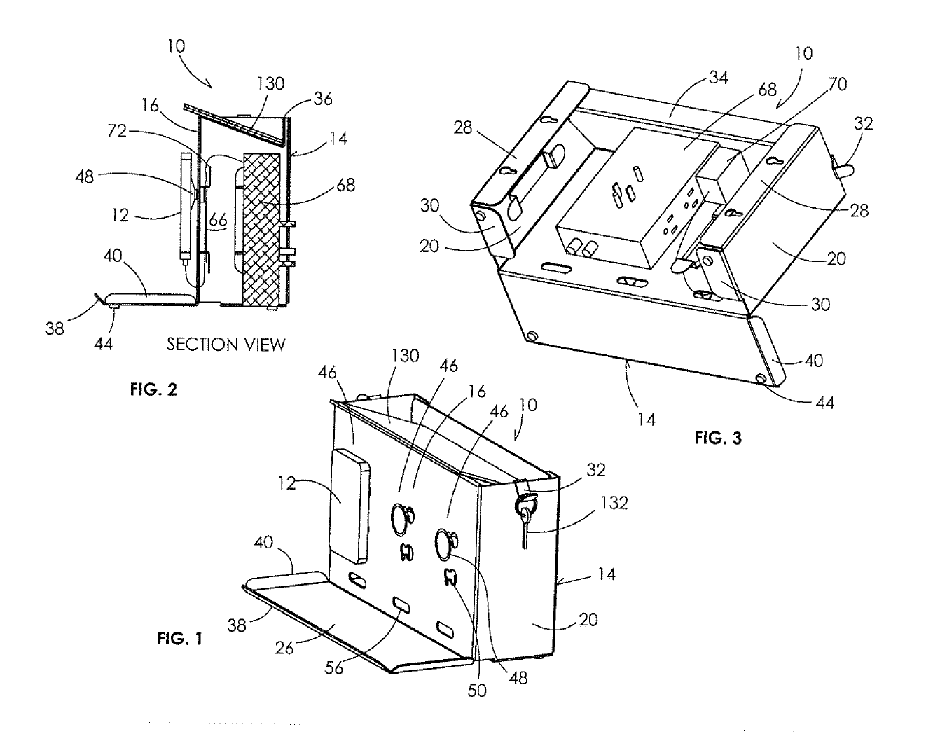

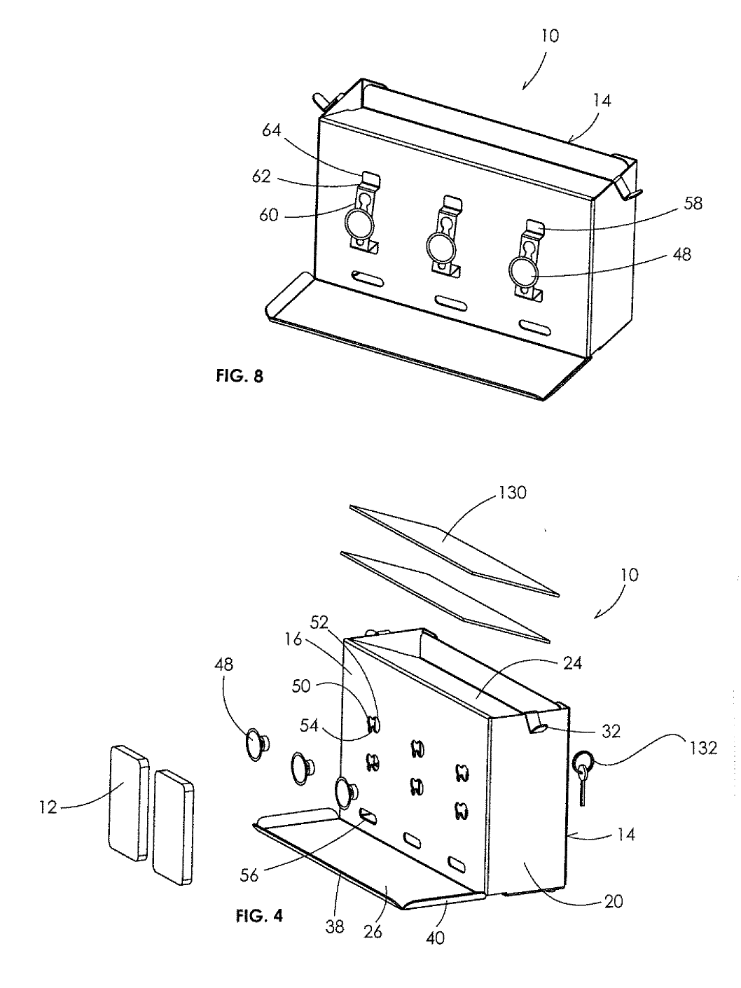

Referring now to the drawings, FIGS. 1 to 7 show a charging station 10 for a portable electronic device 12 according to a first embodiment of the present invention. The illustrated charging station 10 includes a body or base 14 having a substantially vertical and forward facing front wall 16 and a plurality of forward facing fasteners 18 on the wall 16 so that the fasteners 18 can temporarily secure the portable electronic devices 12 to the wall 16 in a position that the portable electronic device can be viewed and operated while recharging. The fastener 18 is temporarily secured to the back of the portable electronic device 12 so that the portable electronic device 12 is held in a substantially vertical and forward facing orientation so that it can be easily viewed and used while recharging and can be easily removed from the fastener 18 when recharging is complete. The illustrated fasteners 18 secure the portable electronic devices 12 against movement in three of the four primary directions within the plane of the front wall 16 (both lateral directions and the downward direction) and in both directions perpendicular to the front wall 16 but permits full 360 degree rotation about an axis perpendicular to the front wall 16. The fastener 18 limits movement of the portable electronic device 12 so that the portable electronic device 12 can be operated with one hand, that is, it is not necessary to hold or stabilize the portable electronic device 12 with one hand while operating it with the other hand. The fastener 18 permits rotation so that the portable electronic device 12 can be moved between portrait landscape orientations. The term “portable electronic device” is used in the specification and claims to mean a handheld electronic device that utilizes rechargeable batteries as a power source including, but not limited to, telephones, personal digital assistants (PDAs), digital cameras, mp3 players, video game players, messaging systems, video players, portable televisions such as LCD televisions, tablet computers, and the like,

The illustrated base 14 includes the vertically-extending and forward facing front wall 16, vertically extending and laterally facing left and right side walls 20, 22 that rearwardly extend from opposed lateral edges of the front wall 16, an inclined top wall 24 rearwardly extending from a top edge of the front wall 16, and a horizontally-extending and upward facing base wall 26 that forwardly extends from a bottom edge of the front wall 16. The illustrated front wall 16 is vertically extending but it is noted that the front wall can alternatively be slightly angled or substantially vertical. The term “substantially vertical.” is used in this specification and claims to mean that the front wall 16 is no more than 45 degrees from vertical so that the portable electronic device 12 secured thereto is substantially vertical and can be easily used and viewed while recharging. The illustrated side walls 20, 22 each include a vertically extending and rearward facing back flange 28 that perpendicularly extends from rear edge of the side wall 20, 22 and a horizontally extending and downward facing bottom flange 30 that perpendicularly extends from a bottom edge of the side wall 20, 22. The illustrated side walls 20, 22 are also each provided with hooks 32 laterally extending from the top edge of the side walls 20, 22. The hooks 32 are preferably sized and shaped for temporarily supporting key rings. The illustrated top wall 24 extends the entire length between the side walls 20, 22 and downwardly inclines in a rearward direction. The illustrated top wall 24 is provided with a vertically extending and rearward facing back flange 34 that extends from a rear edge of the top wall 24. The top wall 24 is sized and shaped to support items such as, for example, the illustrated envelopes or other mail, portable electronic devices and their accessories, other personal items, and the like.

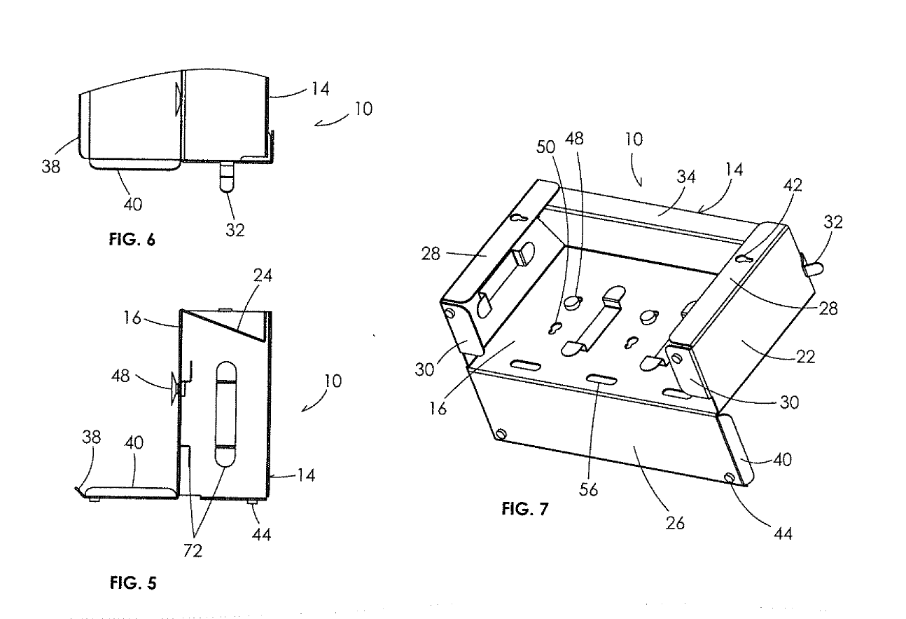

As best shown in FIGS. 5 and 6, the back flange 34 of the top wall 24 is forwardly spaced from the back flanges 28 of the side walls 20, 22 to form a space or gap 36 therebetween. The gap 36 is preferably sized for extending power cords or cables through the gap to personal electronic devices located on the top wall 24. The illustrated base wall 26 is provided with front and side flanges 38, 40 that upwardly incline from front and side edges of the base wall 26 respectively. The base wall flanges 38, 40 are sized and shaped to assist retaining any items lying on the base wall 26 such as, for example, portable electronic devices 12 and their accessories, and the like.

A pair of key-shaped openings 42 is provided on the back flanges 28 of the side walls 20, 22 for securing the base 14 to a wall or other vertically extending support surface. The illustrated key shaped openings 42 are sized for cooperating with #8 size screws but any other suitable size and shape can alternatively be utilized. The illustrated key-shaped openings 42 are oriented in the same lateral direction so that horizontal movement of the base 14 is required for mounting and removal of the base 14 to the wall. It is noted that any other suitable location and/or shape of mounting openings 42 can alternatively be utilized. A plurality of feet 44 is provided on the bottom of the base wall 26 and the side wall bottom flanges 30. The feet 44 are sized, shaped and positioned so that the base 14 can rest in a stable position on top of a horizontal support surface such as a desktop, kitchen countertop, night stand, or the like. It is noted that any other suitable location, quantity, and/or shape of feet 44 can alternatively be utilized. Additionally, double sided suction caps can be provided on the bottom of the base 14 to provide a positive connection between the base 14 the supporting surface. This can be particularly helpful when the supporting surface is smooth and slick such as, for example, granite, to prevent the charging station 10 from sliding when operating the portable electronic device 12. Configured in this manner, the base 14 can be alternatively mounted to a wall or supported on a table top as desired by user.

The illustrated front wall 16 is provided with three laterally spaced-apart attachment locations 46 for the portable electronic devices 12. It is noted that a greater or lesser quantity of attachment locations 46 can alternatively be utilized. The illustrated fasteners 18 at the attachment locations 46 are suction cups 48 which can be easily scoured to the portable electronic devices 12 with suction or vacuum and easily removed from the portable electronic devices 12 when the suction or vacuum connection is broken. As best shown in FIGS. 2 and 5, the illustrated suction cups 48 each have a cup portion for directly engaging the rear side of the portable electronic device 12, a flange portion for securing the suction cup 48 to the front wall 16, and a throat portion connecting the cup portion to the flange portion that is smaller than both the cup portion and the flange portion. It is noted that any other suitable type of suction cup 48 can alternatively be utilized.

Each illustrated attachment location 46 includes a pair of vertically spaced apart key shaped openings 50 and a forward-facing suction cup 48 removably secured to one of the openings 50. Each opening 50 has a first or smaller portion 52 sized for preventing passage of the flange of the suction cup 48 therethrough for retaining the suction cup 48 to the front wall 16 and a second or larger portion 54 sized larger than the first portion 52 for passage of the flange therethrough for installation and removal of the suction cup 48 to the front wall 16. To secure the suction cup 48 to the front wall 16, the flange is inserted through the larger portion 54 of the opening 50 and then the throat portion is moved into the smaller portion 52 of the opening 50 so that the flange cannot be withdrawn. The process is reversed to remove the suction cup 48 from the front wall 16. It is noted that the direction for removing the suction cup 48 is different than the direction for removing the fasteners securing the base 14 to the wall. The suction cup 48 can be selectively moved between the two upper and lower openings 50 of the attachment location 46 depending on the desired position for the portable electronic device 12 or the best location to engage the portable electronic device 12. It is noted that a greater or lesser quantity of the openings 50 and/or the suction cups 48 can alternatively be provided at each attachment location 46. For example, both of the openings 50 can be provided with suction cups 48 to provide greater stability for the portable electronic device 12 and/or there can be three of the openings 50 at each or some of the attachment locations 46 to provide more attachment options.

Each illustrated attachment location 46 is also provided with an opening 56 below the key-shaped openings 50 for passage of cables and/or cords therethrough from the base interior to the personal electronic device 12 located at the attachment location 46 or laying on the base wall 26. The illustrated, openings 56 are horizontally elongated slots but any other suitable size, shape, and/or quantity can alternatively be utilized.

As shown in FIG. 8, spacers 58 can be provided to position the suction cups 48 further forward of the front wall 16 so that there is a larger gap behind the portable electronic device 12 in order to aid in removing the suction cup 48 from the portable electronic device 12. The illustrated spacers 58 have a vertically extending main portion 60 in which a the vertically spaced-apart openings 50 are provided in, horizontally extending spacing portions 62 rearwardly extending from the upper and lower ends of the main portion 60, and vertically extending attachment portions 64 upwardly and downwardly extending from the upper and lower spacing portions 62 respectively. The attachment portions 64 engage and are secured to the front wall 16 in any suitable manner such as, for example, double sided tape and the like. It is noted that the spacers 58 can alternatively have any other suitable shape and size.

The walls 16, 20, 22 of the illustrated base 14 form an interior space 66 for housing an outlet or wall-plug style surge protector or power adapter 68 and AC/DC converters 70 for supplying power to the portable electric devices 12. The illustrated power adapter 68 includes a grounded plug located at a rear side of the adapter and six grounded receptacles outlets located on lateral sides of the adapter 68. It is noted that any other suitable power adapter 68 can alternatively be utilized. It is also noted that the illustrated power adapter 68 is not secured to the base 14. To recharge/power the portable electronic devices 12, the power adapter 68 is inserted to a wall electrical power outlet or receptacle and the AC DC converters 70 are inserted into both the power receptacles of the power adapter 68 and the appropriate connectors on the portable electronic devices 12. For portable electronic devices 12 located at the attachment locations 46 or laying on the base wall 26, the cords or cables of the AC/DC converters 70 extend through the openings 56 in the front wall 16. For portable electronic devices 12 lying on the top wall 24, the cords or cables of the AC/DC converters 68 extend through the gap 36 between the top wall 24 and the rear flanges 28 of the side walls 20, 22. The illustrated base 14 is provided with a plurality of cord wraps 72 within the interior space 66 so that excess lengths of the cords or cables can be wound about the cord wraps 72. The illustrated base 14 has four cord wraps 72 that are secured to the interior sides of the side walls 20, 22 and the front wall 16 between the attachment locations 46. The cord wraps 72 can be secured to the walls 16, 20,22 in any suitable manner. It is noted that any other quantity, type, and/or locations of the cord wraps 72 can alternatively be utilized,

The illustrated base 14 is formed from a suitable sheet metal such as, for example, a steel sheet metal. It is noted, however, that the base 14 can alternatively be manufactured from a different process such as, for example, injection molding and the like and/or a different material such as, for example plastic, wood, and the like.

The illustrated charging station 10 is mounted to a wall over a wall electrical power outlet. Preferably inserts are positioned in the wall above and on opposed sides of the wall outlet. Protruding screws are positioned in the inserts. With the adapter 68 plugged into the wall outlet, the AC/DC converters 70 positioned within the charging station 10 are plugged into the adapter 68 and the base 14 is secured to the wall over the wall outlet and the adapter 68. The base 14 is secured to the wall by inserting the heads of the screws through the large portion of the openings 42 in the back flanges 28 and then moving the base 14 laterally to move the screws into the small portion if the openings 42 so that the screws cannot be withdrawn. With the base 14 secured to the wall in this manner, portable electronic devices 12 can be removably secured to the suction cups 48 and connected to the AC/DC adapters 70 so that they can be recharged. To remove the portable electronic devices 12, the portable electronic devices 12 can be removed from the suction cups 48 or the suction cups 48 can be removed from the front wall 16 (with an upward motion in the illustrated embodiment) and then removed from the portable electronic device 12. This second method of removal can be helpful when it is difficult to get a finger behind the portable electronic device 12 to the suction cup to break the vacuum. Mounted in this position, the portable electronic devices 12 are positioned so that they can be easily used while recharging. Portable electronic devices 12 can alternatively be laid on the base wall 26 or the top wall 24 if desired. Additionally, mail can be placed on the top wall 24, keys can be placed on the hooks 32, and personal items can be placed on the base wall 26.

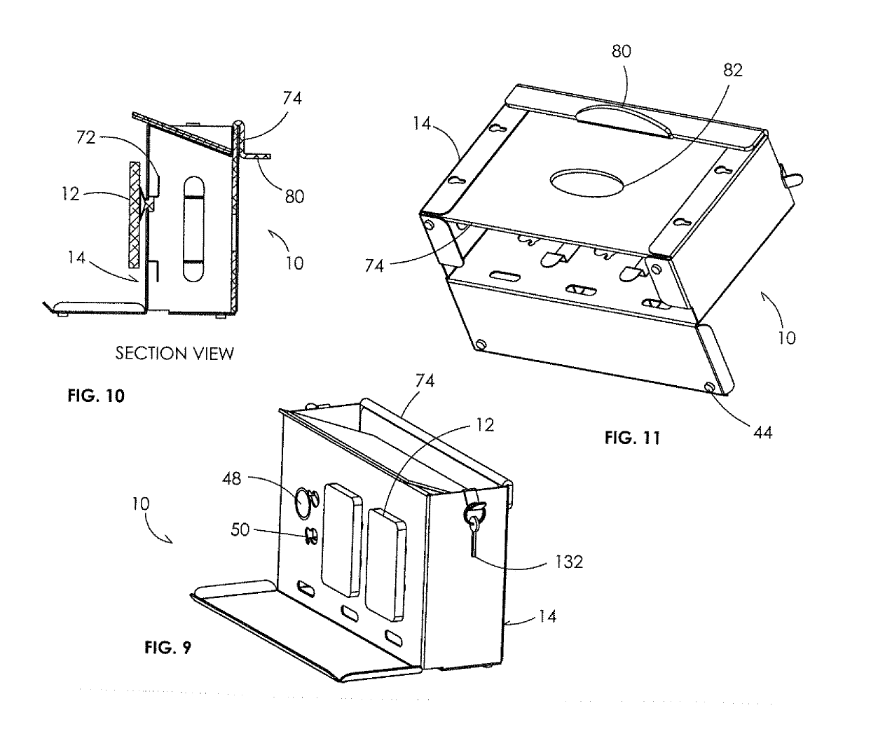

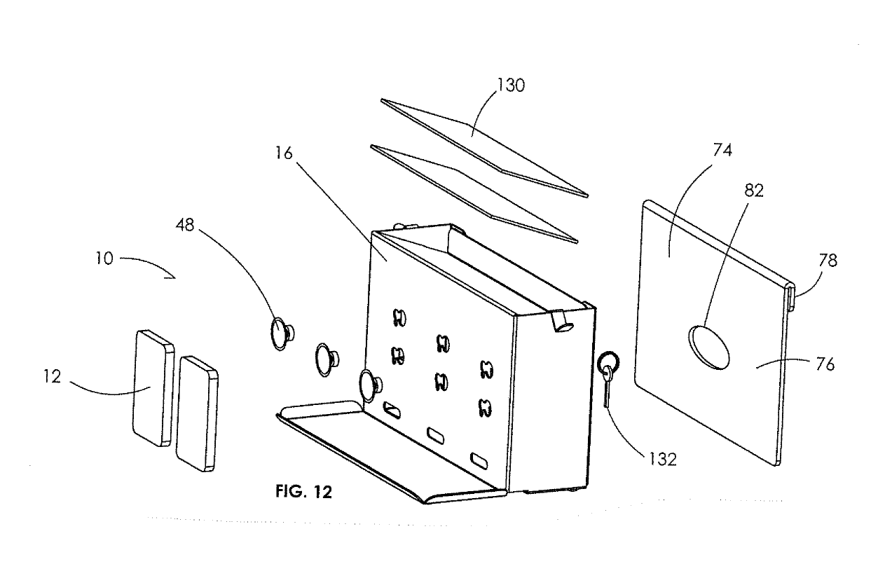

The charging station 10 can alternatively be supported on a table top rather than secured to a wall. FIGS. 9 to 12 illustrate a back cover 74 that can be utilized to substantially close the back opening of the base 14 when the charging station 10 is used in a table top configuration. The illustrated cover 74 has a main portion 76 having a thickness sized so that it can slide down through the gap 36 formed between the back flanges 28 of the side walls 20, 22 and the flange 34 of the top wall 24 (best shown in FIG. 10). A flange portion 78 of the illustrated back cover 74 extends downwardly from the top of the main portion 76 and substantially parallel to the main portion 76 to receive the tops of the side wall back flanges 28 therebetween. The illustrated back cover 74 also is provided with a handle portion 80 centrally located on the flange portion 78 for inserting and removing the back cover 74. An opening 82 is provided in the main portion 76 of the back cover 74 to extend cords or cables to a wall electrical power outlet. It is noted that the adapter 68 can be positioned either at the wall outlet or within the base 14. The illustrated opening 82 is oval shaped but any other suitable shape can be utilized. The illustrated back cover 74 is formed of acrylic but it is noted that any other suitable material can be utilized.

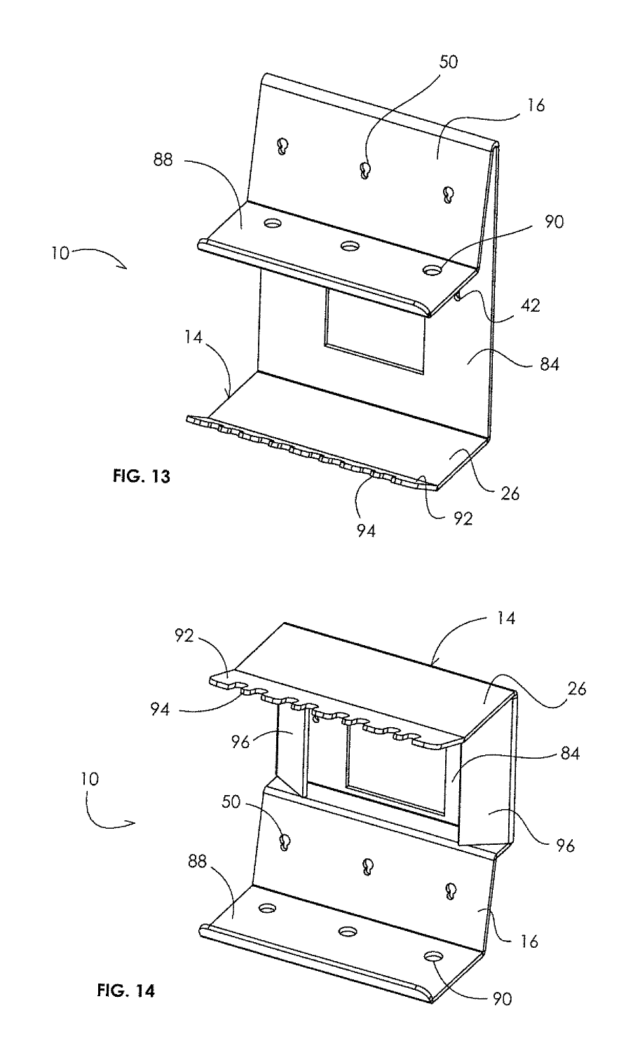

FIG. 13 illustrates a charging station 10 for a portable electronic device 12 according to a second embodiment of the present invention. This embodiment illustrates that the base 14 can take other forms. The illustrated base 14 of this embodiment includes a hack wall 84 with an opening 86 for a wall electrical power outlet and key-shaped openings 42 for screws to secure the back wall 84 to a wall. A front wall 16 downwardly extends from the top of the back wall 84 such that it is substantially vertical and is provided with three attachment locations 46 for the portable electronic devices 12. The suction cups 48 are secured the same as described above with regard to the first embodiment of the present invention. A horizontal support wall 88 forwardly extends from the bottom of the front wall 16 and is provided with openings 90 for the passage of cords or cables therethrough. A horizontal base wall 26 forwardly extends from the bottom of the back wall 84 and is provided with a flange 92 forming hooks in mounting points 94 for key rings at its forward end. This embodiment also illustrates that the base 14 can be formed of acrylic.

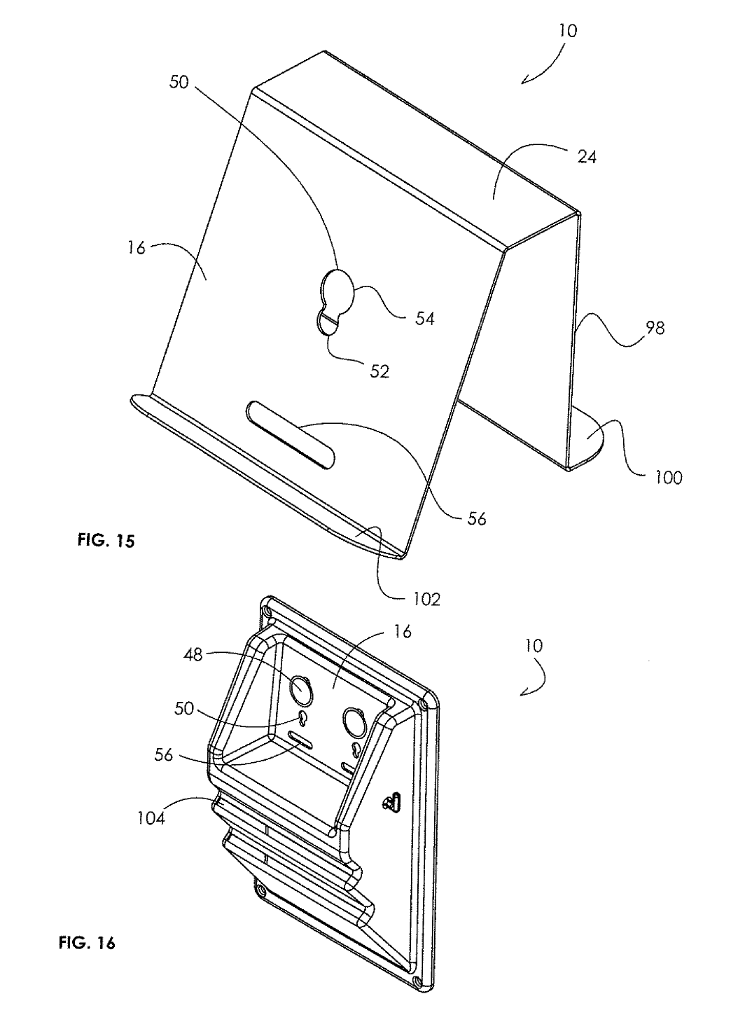

FIG. 14 illustrates a charging station 10 for a portable electronic device 12 according to a third embodiment of the present invention. This embodiment further illustrates that the base 14 can take other forms. This base 14 is substantially the same as to the base 14 of the second embodiment described above except that the front wall 16 and the base wall 26 are reversed so that the base wall 26 extends from the top of the back wall 84 and the front wall 16 extends from the bottom of the back wall 84. This embodiment also illustrates that additional walls can be provided to more fully conceal the adapter. The illustrated base 14 has a pair of side walls 96 inwardly angling from sides of the back wall 84.

FIG. 15 illustrates a charging station 10 for a portable electronic device 12 according to a fourth embodiment of the present invention. This embodiment further illustrates that the base 14 can take other forms. The illustrated base 14 is formed for use on a table top and has a substantially horizontal top wall 24, a substantially vertical back 98 wall downwardly extending from the rear of the top wall 26 and provided with a rearwardly extending horizontal flange 100 at its lower end, and a substantially vertical front wall 16 downwardly extending from the front of the top wall 26 and provided with a forwardly extending horizontal flange 102 at its lower end. The term “substantially vertical” is used to mean that the front wall 16 is no more than 45 degrees from vertical so that the portable electronic device 12 secured thereto can be easily used while recharging. The front wall 16 is provided with a single attachment location 46 for the portable electronic device 12 having a single opening 50 for the suction cup 48. The suction cup 48 is secured the same as described above with regard to the prior embodiments of the present invention. The front wall 16 and is provided with an opening 56 below the suction cup 48 for the passage of a cord or cable therethrough. This embodiment also further illustrates that the base 14 can be formed of acrylic. It is noted that this embodiment of the configuration enables a portable electronic device 12 to be supported on a nightstand and used as an alarm clock.

FIG. 16 illustrates a charging station 10 for a portable electronic device 12 according to a fifth embodiment of the present invention. This embodiment further illustrates that the base 14 can take other forms and that the base 14 can be molded of a plastic. The illustrated base 14 forms a hollow interior for mounting over a wall electrical power outlet and includes a plurality of slots 104 for storing mail such as, for example, envelopes.

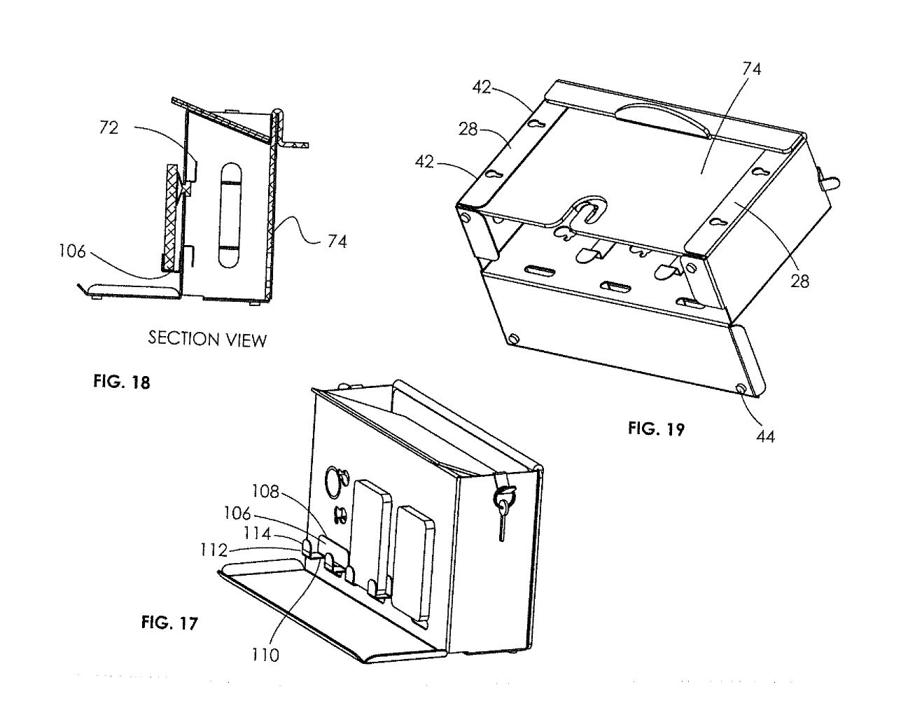

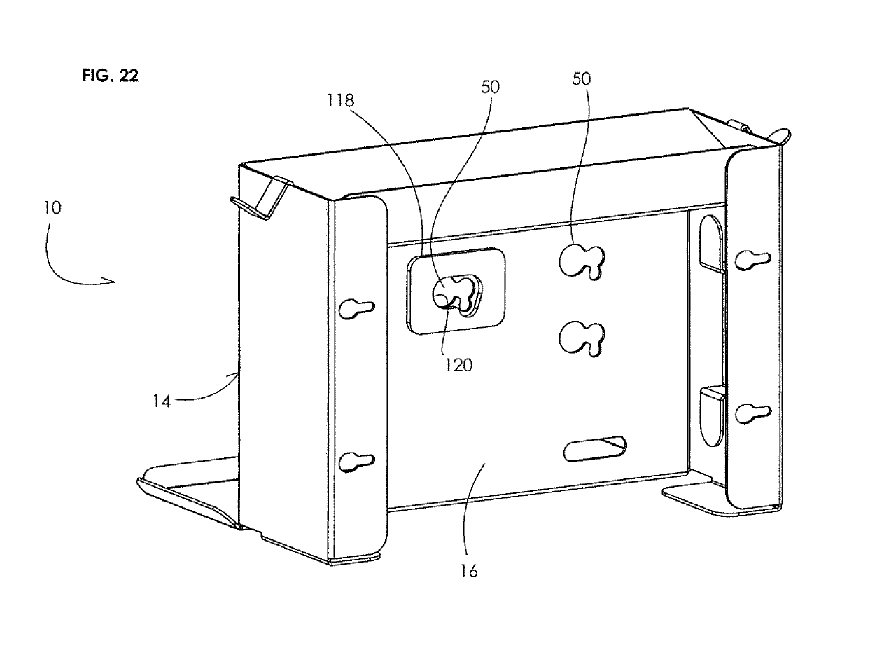

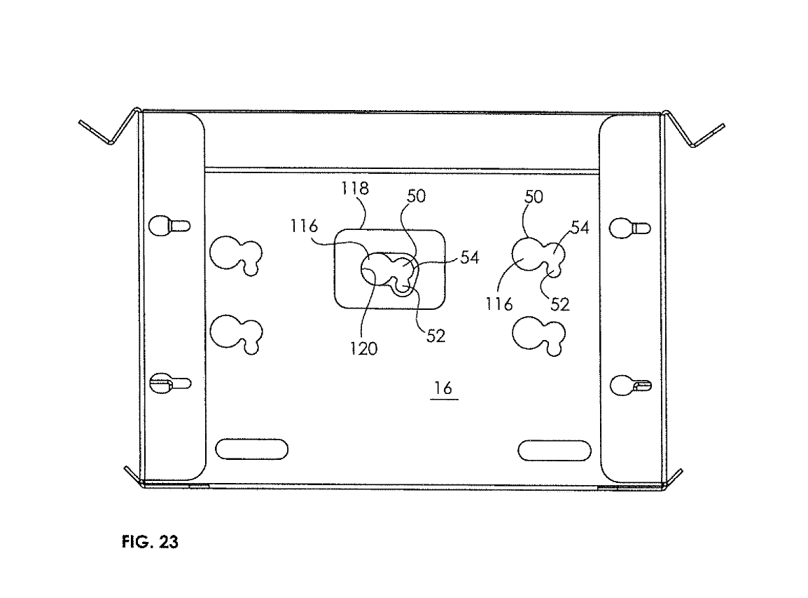

FIGS. 17 to 26 illustrate a variation of the charging station 10 of FIGS. 1 to 12. This variation of the charging station 10 is substantially the same except as described hereinbelow. This charging station 10 is provided with bottom supports or cradles 106 secured to the front wall 16 below the suction cups 48. The bottom supports 106 can limit downward movement of the portable electronic devices 12 if connections with the suction cup 48 inadvertently break or to provide additional support for the portable electronic device 12 when attached to the suction cup 48. The bottom support 106 is particularly desirable in this regard when a user expects to leave a portable electronic device 12 secured to the suction cup 48 for an extended period of time or the user desires a “peace of mind” that the portable electronic device 12 will not accidentally fall. The bottom support 106 can also be useful to establish the suction cup height relative to the bottom of the portable electronic device 12. For example, if a portable electronic device 12 has a specific area which must be secured to the suction cup 48 (because portions of the portable electronic device 12 are unsuitable for an adequate connection with the suction cup 48), the bottom support 106 can be positioned to align the desired area with the suction cup 48 when the portable electronic device 12 is resting on the bottom support 106. Thus, the portable electronic device 12 can be easily secured to the suction cup 48 by first resting the portable electronic device 12 on the bottom support 106 and then rearwardly moving the portable electronic device 12 to engage the suction cup 48 thereto.

The illustrated bottom support 106 has a rear wall 108 for connection to the front wall 16 of the base 14 and a pair of laterally spaced-apart flanges 110 forwardly extending from the bottom edge of the rear wall 108. The flanges 110 have a horizontal bottom portion forwardly extending from the bottom edge of the rear wall 108 and a substantially vertical front portion 112 upwardly extending from a forward edge of the bottom portion 110. The illustrated flanges 110 are sized and shaped so that they limit downward movement of the portable electronic device 12 but do not limit or prevent movement in the upward or lateral directions. Movement in the upward and lateral directions is prevented by the suction cup or cups 48. It is noted that the bottom support 106 can alternatively have any other suitable configuration such as, for example, there can be a single but wider flange 110 and/or the front portions 112 of the flanges 110 can be eliminated. The bottom support 106 can be secured to the base 14 using Command Strips available from the 3M Co. Dual Lock fasteners available from the 3M Co., hook and loop fastener, adhesive, double sided pressure-sensitive adhesive tape, mechanical fasteners, or any other suitable fastening means. The bottom support 106 can be formed of metal, plastic, wood and/or any other suitable material. The illustrated front portions 112 are provided with soft plastic caps 114 to ensure that the bottom support 106 does not scratch or otherwise damage the portable electronic device 12.

As best shown in FIG. 19, the back flanges 28 of the base side walls 20, 22 are provided with an additional pair of key-hole shaped openings 42 for securing the base 14 to the wall. The illustrated base 14 has two pairs of openings 42 but any other suitable quantity of openings 42 can alternatively be utilized. The openings 42 are preferably oriented in the same direction so that additional fasteners can be used to secure the base 14 to the wall to obtain additional rigidity if desired.

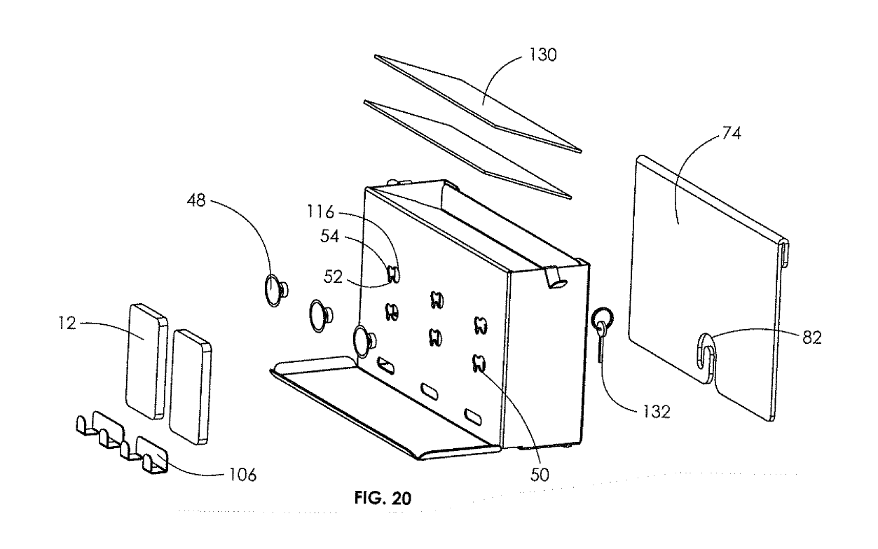

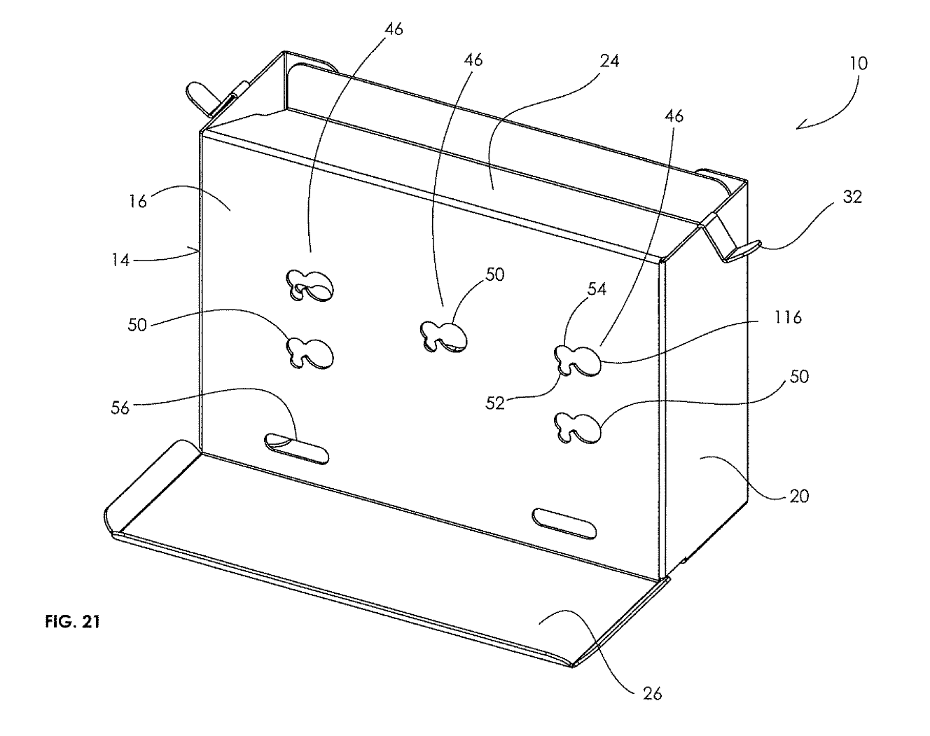

As best shown in FIGS. 19 and 20, the opening 82 in the rear cover 74 for the wires or cords is an inverted J-shaped path which opens into the bottom edge of the back cover 74. Shaped in this manner any portion of the cords or wires can be fed into the opening 82 from the edge of the back cover 74 rather than needing to feed an end of the cords or wires through the closed opening 82. It is noted that the opening 82 can alternatively have any other suitable shape which opens into the bottom edge of the back cover 74.

As best shown in FIG. 20, the openings 50 for securing the suction cups 48 to the front wall 16 are double-key shaped. That is, each of the openings 50 has the first portion 52 sized for preventing passage of a flange of a small suction cup 48 therethrough for retaining the suction cup 48 to the front wall 16, a second portion 52 sized larger than the first portion 50 for passage of the flange of small suction cup 48 therethrough for installation and removal of the small suction cup 48 to the front wall 16 and sized for preventing passage of a flange of larger suction cup 48 therethrough for retaining the larger suction cup 48 to the front wall 16, and third portion 116 sized larger than the second portion 54 for passage of flange of the larger suction cup 48 therethrough for installation and removal of the larger suction cup 48 to the front wall 16. The first, second and third portions 52, 54, 116 of the openings 50 are sized so that a small sized suction cup 48 can be inserted into the intermediate portion 54 and slid downward to the small portion 52 to secure the suction cup 48 to the front wall 16 and so that a large sized suction cup 48 can be inserted into the large portion 116 and slid sideways to the intermediate portion 54 to secure the suction cup 48 to the front wall 16. The portions 52, 54, 116 of the illustrated openings 50 are positioned so that the path for the large suction cups 48 is substantially perpendicular to the path for the small suction cups 48. Note that the direction of removal for each of the suction cups 48 is in a different direction than the openings 42 for attachment of the base 14 to the wall. It is noted that the large suction cups 48 mounted in this mariner limit or prevent movement of the portable electronic devices 12 in three of the four primary directions within the plane of the front wall 16 (one lateral directions, the upward direction, and the downward direction) and in both directions perpendicular to the front wall 16 but permits full 360 degree rotation about an axis perpendicular to the front wall 16. The small suctions cups 48 operate the same as discussed above for the single key opening.

These double-keyed openings 50 permit the use of a small or a large suction cup 48 in the same opening 50 depending on the requirements of the portable electronic device 12 rather then using more than one suction cup 48. When using a single suction cup 48, the portable electronic device 12 can be rotated to other orientations as desired such as, for example rotating the portable electronic device 12 to a landscape orientation. The portable electronic device 12 can also be easily rotated to pull the portable electronic device 12 out of the suction cup opening 50 if the battery cover of the portable electronic device 12 is removed in the vertical axis. The user can also use two suction cups 48 (any combination of small and large suction cups 48) if redundancy and/or more rigidity is desired.

FIGS. 21 to 23 illustrate a charging station 10 for a portable electronic device 12 according to a sixth embodiment of the present invention. This embodiment further illustrates that the base 14 can take other forms. This embodiment is substantially the same as the first embodiment except that it is sized smaller. This embodiment is sized for holding a tablet computer such as for example, a iPad available from Apple. Inc., in the landscape position or two side-by-side smart phones such as, for example, an iPhone available from Apple, Inc. There is a centrally located attachment location 46 having a single opening 50 which is useful for securing a large suction cup 48 for the tablet computer. There are also attachment locations 46 on opposed sides of the central attachment location 46 that each have a pair of vertically spaced-apart openings 50 which are useful for securing small suction cups 48 for the smart phones.

The illustrated central opening 50 is provided with a stop plate 118 on the rear side of the front wall 16. The stop plate 118 provides an abutment along a portion of the opening 50 so that the flange of the suction cup 48 does not engage the rear side of the front wall 16 when it is to be withdrawn from the opening 50. As the suction cup 48 is laterally moved from the second or intermediate portion 54 to the third portion 116 for withdrawal, the flange engages the stop plate 118 and deforms rather than moving behind the front wall 16 along the edge of the third portion 116. With the suction cup flange deflected in this manner, it is easier to withdraw the suction cup 48. The illustrated, stop plate 118 encircles the entire opening 50 but only closely follows the side of the third portion 116 opposite the second portion 54 and does not affect the flange when in the other sections 52, 54 of the opening 50. The illustrated stop plate 118 follows about half of the third section 116 of the opening 50. It is noted that the stop plate 118 can have any other suitable form to provide the abutment 120 for deforming a portion of the suction cup flange. The stop plate 118 can be secured to the rear side of the front wall 16 in any suitable manner such as, for example, double sided tape and the like.

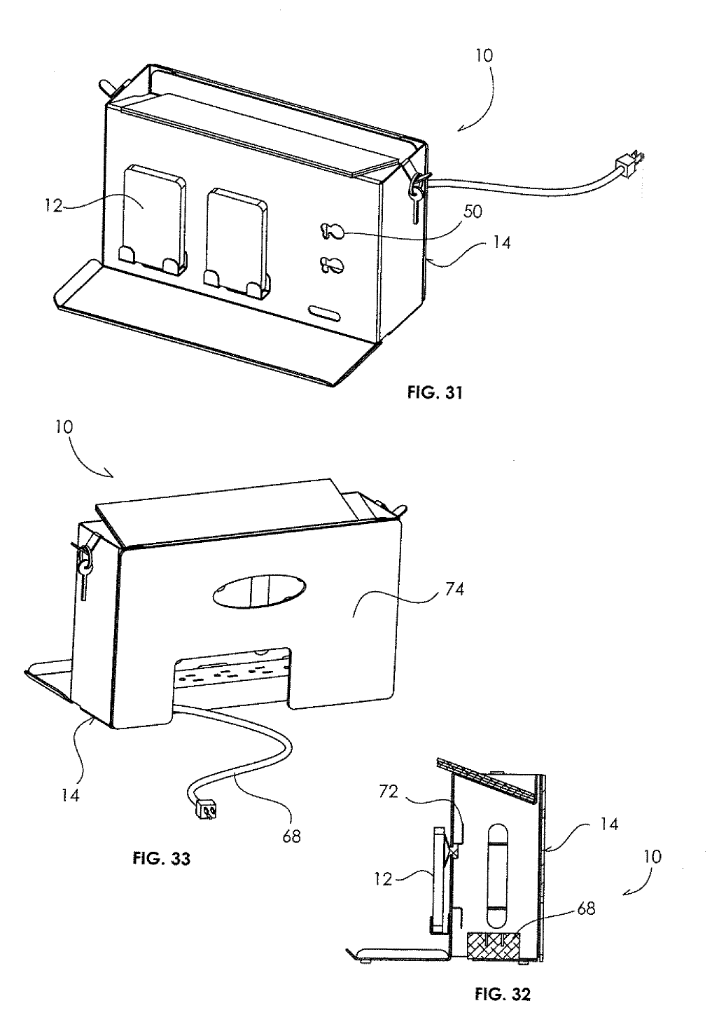

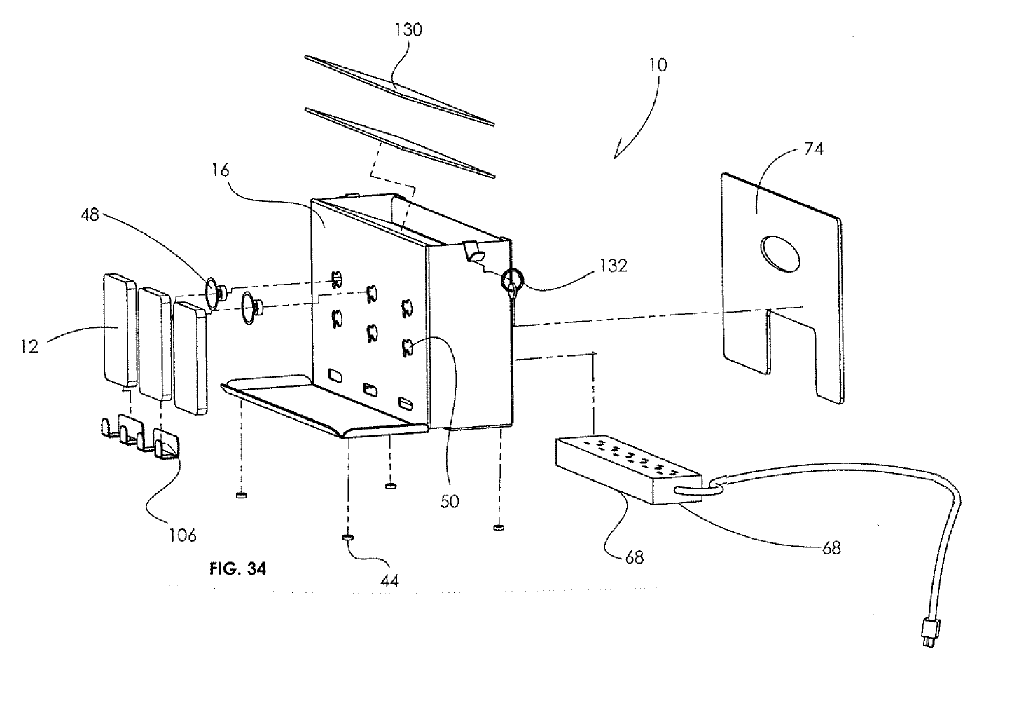

FIGS. 31 to 34 illustrate a charging station 10 for a portable electronic device 12 according to another variation of the first embodiment of the present invention. This variation is substantially the same as the first embodiment except that it the outlet or wall-plug style surge protector 68 is replaced with a strip-style surge protector 68 to eliminate the need for the base 14 to be installed over a wall electrical power outlet. This permits the charging station 10 to be mounted on any wall or other vertical support surface. The strip-style surge protector or power adapter 68 can be supported within the base 14 on the bottom flanges 30 of the side walls 20,22 or in any other suitable manner

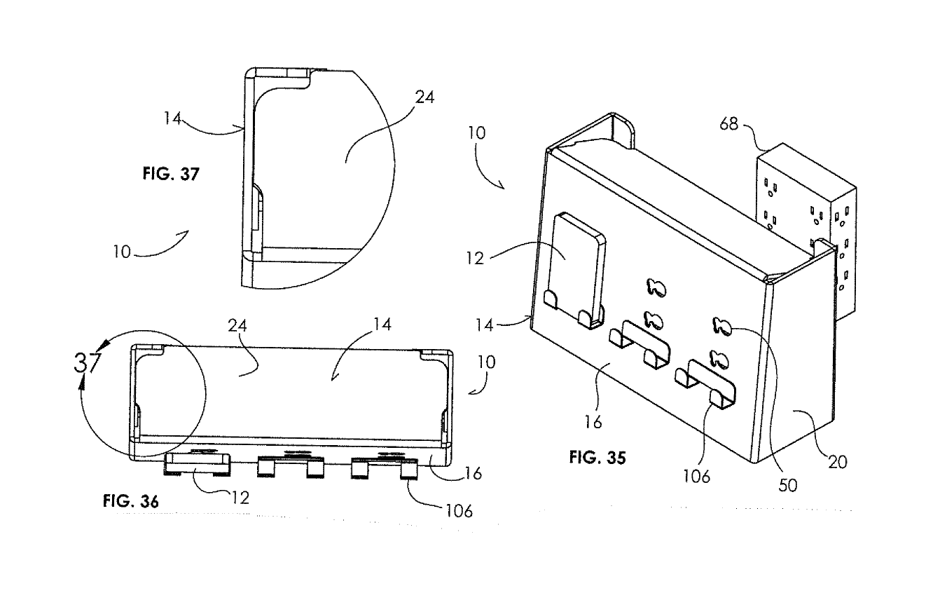

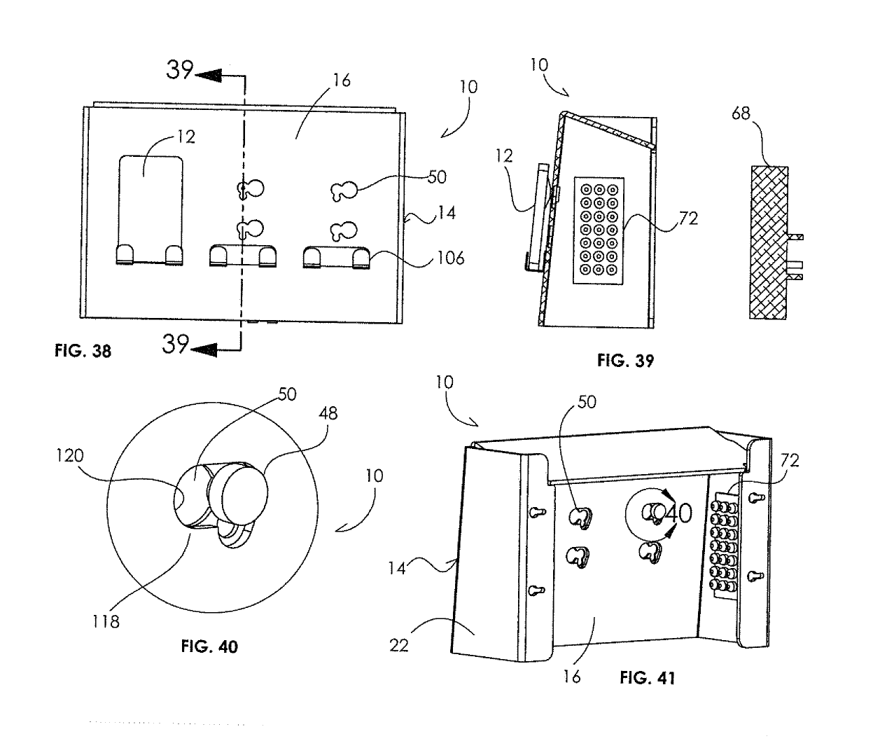

FIGS. 35 to 41 illustrate a charging station 10 for a portable electronic device 12 according to a seventh embodiment of the present invention. This embodiment further illustrates that the base 14 can take other forms. This embodiment is substantially the same as the first embodiment except that it is modified to reduce cost. The base wall 26 and the hooks 32 are each eliminated and the base 14 is formed of Acrylic rather than sheet metal. The cable openings 56 are eliminated and wires are routed through the open bottom of the base 14 to the portable electronic devices secured on the front wall 16. The cord wraps or cable management systems 72 are in the form of a cable bundler available from Cablox, Inc. The cable bundler can be cut to the desired size and secured to inner side of the side walls 20, 22 with double sided tape or the like in order to further eliminate welds. A small adhesive cable clip can be mounted on the front bottom center to control the cable going to the middle attachment location 46.

This embodiment also shows that the stop plate 118 can be integrally formed with the front wall 16. The illustrated stop plate is formed by milling a recess in the rear side of the front wall about the opening 50 to form the abutment 120. This version of the stop plate operates in the same manner as described above but eliminates the need for a separate component.

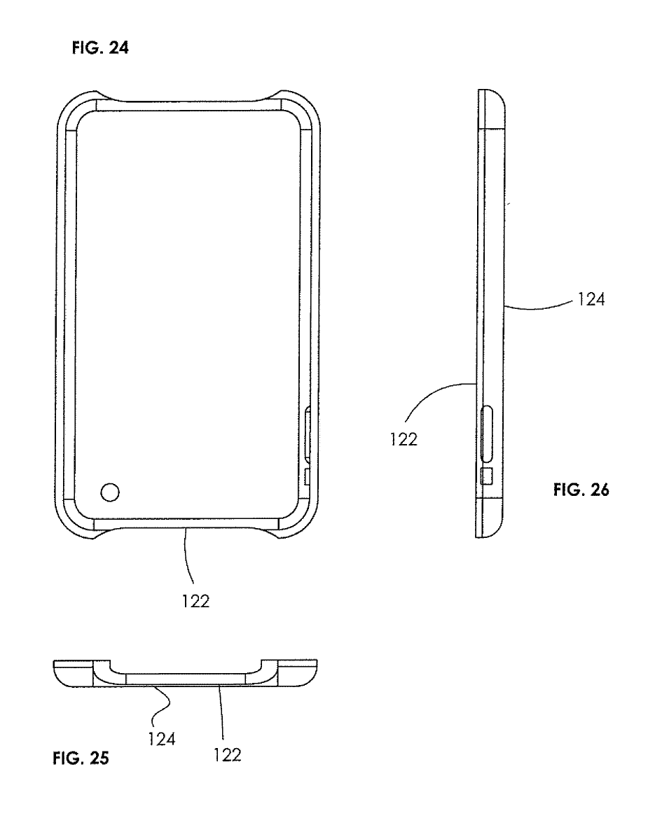

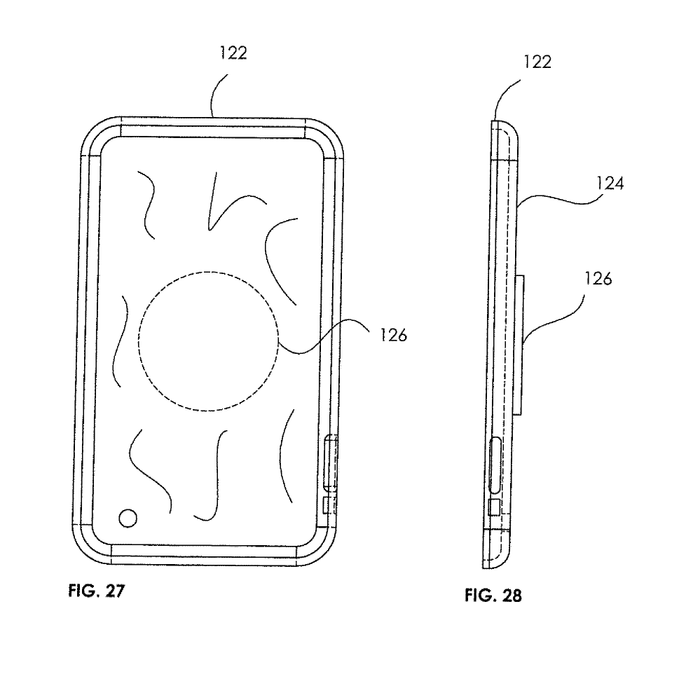

FIGS. 24 to 26 illustrate a sleeve or cover 122 for a portable electronic device 12 in the form of a smart phone such as, for example, an iPhone available from Apple Inc., but the sleeve can be adapted for any other suitable type of portable electronic device 12. The illustrated sleeve 122 easily snaps onto and off of the portable electronic device 12 and provides a hard planar rear surface 124 for attachment of the suction cup 48 thereto. The sleeve 122 is useful when the portable electronic device 122 does not have a rear surface suitable for attachment of the suction cup 48 thereto and/or when the user of the portable electronic device 12 prefers to have a cover or sleeve 122. The illustrated sleeve 122 comprises a relatively hard plastic but any other suitable material can alternatively be utilized. It is noted that the sleeve 122 can alternatively have any other suitable form that provides a suitable attachment surface 124 for the suction cup 48. FIGS. 27 and 28 illustrate a rear surface 124 of a sleeve or cover 122 that is primarily comprised of a material or surface that is unsuitable for attachment of the suction cup 48 but has an attachment puck 126 thereon which forms a suitable hard planar surface for attachment of the suction cup 48. For example, the sleeve 122 can comprise leather with a plastic puck 126 attached thereto or embedded therein. The illustrated puck 126 is circular but the puck 126 can have any other suitable size and/or shape.

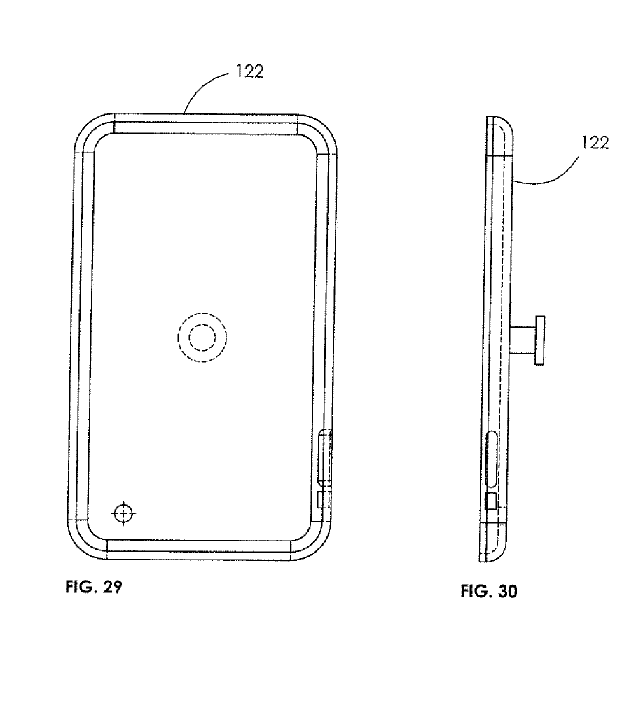

The above illustrated removable fasteners 18 comprise the openings 50 and the suction cups 48 but they can be any other suitable removable fastener 18 for temporarily securing the portable electronic devices 12 to the front wall 16 such as for example, hook and loop fasteners, Command Strips available from the 3M Co., and Dual Lock fasteners available from the 3M Co., clips, peg and slot connections, and the like. The suction cups 48, however, are preferred over other removable fasteners that require something to be bonded or otherwise secured to the portable electronic device 12. This can somewhat be avoided by utilizing the sleeve 122 but it is preferred not to be required to utilize the sleeve 122 for all portable electronic devices 12 because some users prefer not to use sleeves or covers 122. FIGS. 28 and 29 illustrate a sleeve 122 having a flanged pin or peg 128 which cooperates with the keyhole openings 50 or the like. It is noted that the peg 128 and the openings 50 can be reversed on the front wall 16 and the sleeve 122 if desired. It is also noted that any other suitable type of removable fastener 18 can alternatively be utilized.

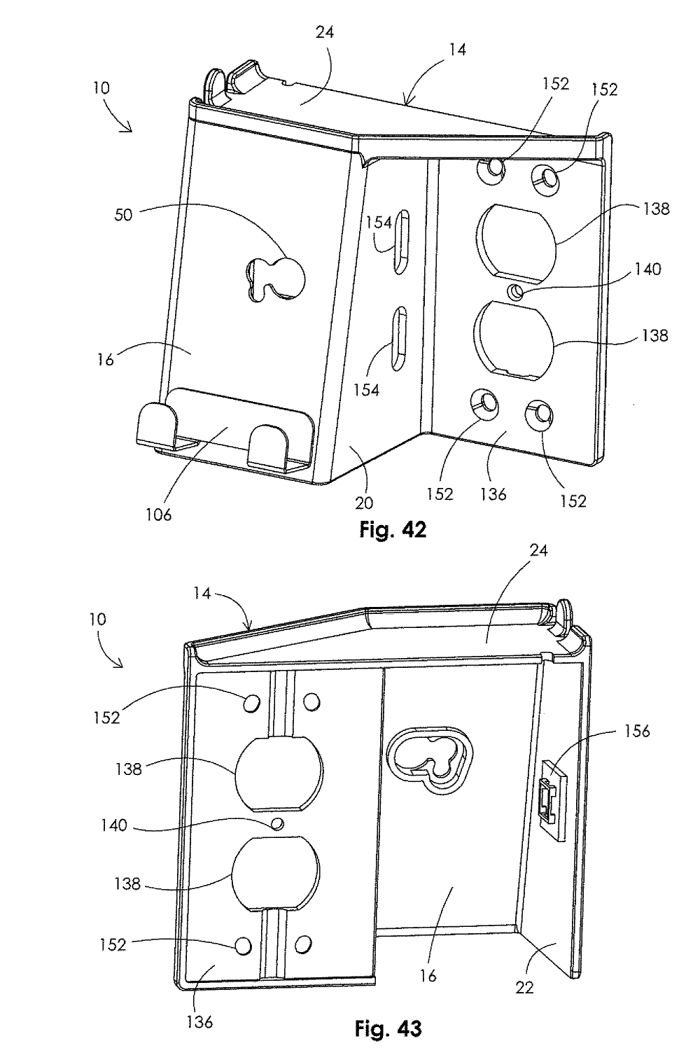

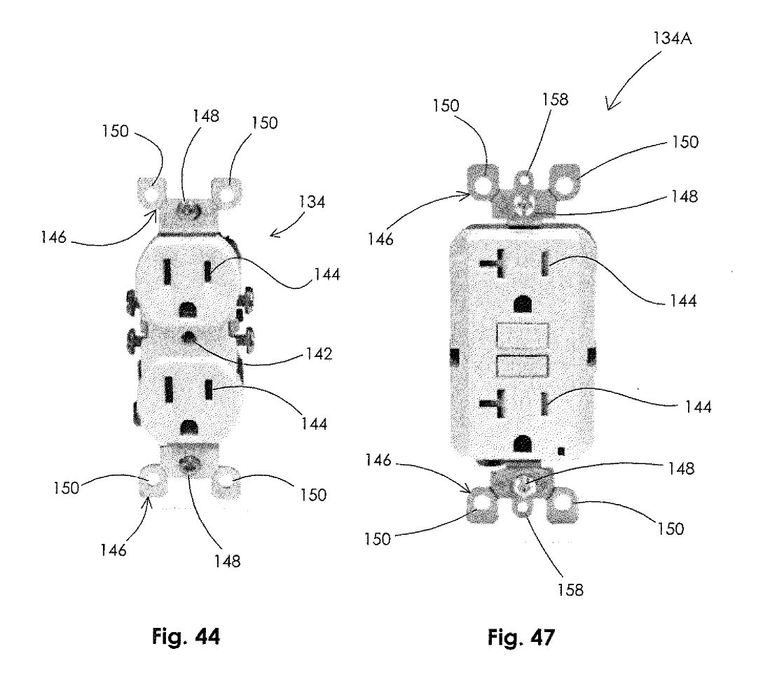

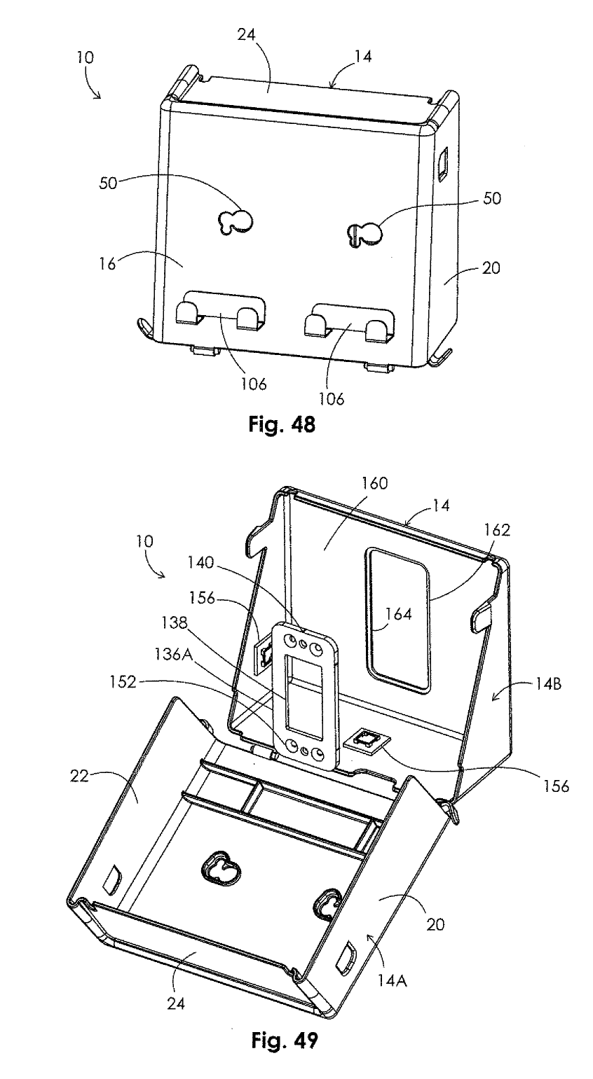

FIGS. 42 and 43 illustrate a charging station 10 for a portable electronic device 12 according to an eighth embodiment of the present invention. This embodiment further illustrates that the base 14 can take other forms. This embodiment is substantially the same as the first and other embodiments except that it is modified to have a single attachment location 46 which holds a single portable electronic device 12 and to be secured directly to a standard wall electrical outlet or receptacle 134 (see FIG. 44) rather than directly to the wall. This embodiment also enables the base 14 to be easily molded of a suitable polymeric material in order to reduce cost. The illustrated front wall 16 has a single opening 50 for removably securing a suction cup 48 to the front wall and a single bottom support 106 located below the opening 50. The illustrated base 14 replaces the mounting flanges 28 with an attachment cover plate 136 that is adapted to be secured directly to the standard wall electrical receptacle 134 in place of a standard cover plate that typically covers the standard wall electrical receptacle 134. The illustrated attachment cover plate 136 is integrally formed with the side wall 20 and extends outwardly and perpendicularly from a rear end of the side wall 20. The illustrated top wall 24 extends entirely between the side walls 20, 22 and across the top of the attachment cover plate 136. The illustrated top wall 24 is horizontal and is provided with a pair of hooks 32 for hanging key rings or other suitable items to be stored and a wire routing notch located at a rear edge of the top wall 24. The wire routing notch enables a cable to be routed from the interior space 66 of the base 14 to a portable electronic device 12 which is located on the top wall 24. It is noted that more than one wire routing notch can be provided in the rear edge of the top wall 24 if desired (for example, see FIGS. 48 and 49).

The attachment cover plate 136 includes at least one outlet opening 138 for the passage of an electrical plug to the wall electrical receptacle 134 and at least one fastener opening 140 for a mechanical fastener to rigidly secure the base 14 to the wall electrical receptacle 134. The illustrated attachment cover plate 136 is adapted to be secured to a Type A or Type B North American electrical outlet and thus has a pair of the outlet openings 138 located one above the other and a single fastener opening 140 located between the outlet openings 138 for cooperation with a central threaded opening 142 of the wall electrical receptacle 134. It is noted that the attachment cover plate 136 can alternatively be adapted to be secured to any other suitable type of wall electrical outlet 134. FIG. 44 illustrates a standard Type B North American electrical outlet having a pair of three prong receptacles 144 located one above the other and the central threaded opening 142 located between the receptacles 144. Mounting straps 146 are located on the top and bottom of the wall outlet receptacle 134 which each include a fastener 148 for securing the wall outlet receptacle 134 to a wall box and a pair of additional fastener openings 150. The illustrated attachment cover plate 136 is also provided with four additional fastener openings 152 in a rectangular pattern, with two located above the outlet openings 138 and two located below the outlet openings 138, for passage of mechanical fasteners to the four additional fastener openings 150 on the mounting straps 146 of the wall electrical receptacle 134. The illustrated body 14 is secured directly to the wall electrical outlet 134 with these five mechanical fasteners but it is noted that the body 14 can alternatively be directly secured to the wall electrical outlet 134 with any other quantity of mechanical fasteners and/or in any other suitable manner.

Cable openings 154 are provided in the side wall 20 adjacent the outlet openings 138 so that electrical wires/cables can be routed from the wall electrical outlet 134 to the interior space 66 of the base 14. The illustrated cord wraps or cable management systems 72 are in the form of cable mounting pads 156 secured to body 14 and cable ties. It is noted that alternatively the cable mounting pads 156 can be integrally molded with the body 14 and or any other suitable cord wraps or cable management systems can alternatively be utilized. The cable openings 56 in the illustrated front wall 16 are eliminated and cables/wires are routed through the open bottom of the base 14 to the portable electronic devices 12 secured on the front wall 16.

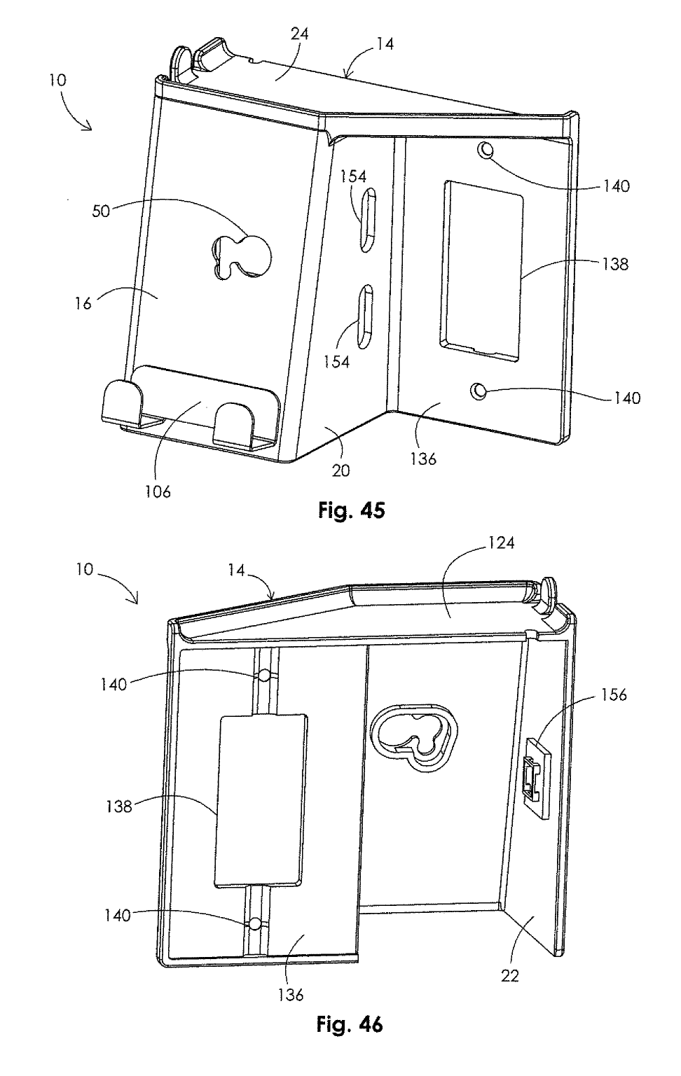

FIGS. 45 and 46 illustrate a charging station 10 for a portable electronic device 12 which is a variation of the embodiment of FIGS. 42 and 43. This embodiment further illustrates that the base 14 can take other forms. This variation is substantially the same as the eighth embodiment except that it is modified to be secured directly to a GFCI North American will electrical outlet or receptacle 134A (see FIG. 45) rather than a Type B North American wall electrical outlet or receptacle 134 (see FIG. 44). The illustrated attachment cover plate 136 has a single rectangular-shaped outlet opening 138 and a pair of fastener openings 140 located at opposed upper and lower ends of the outlet opening 138 for cooperation with mounting openings 158 of the wall electrical receptacle 134A. FIG. 45 illustrates a standard GFCI North American electrical outlet 134A having a pair of three prong receptacles 144 located one above the other and centrally-located mounting openings 158 located on mounting straps 146 above and below the receptacles 144. The mounting straps 146 are located on the top and bottom of the wall outlet receptacle 134A and also each include a fastener 148 for securing the wall outlet receptacle 134A to a wall box and a pair of additional fastener openings 150. It is noted that the attachment cover plate 136 can alternatively be provided with four additional fastener openings in a rectangular pattern, with two located above the outlet opening 138 and two located below the outlet opening 138, for passage of mechanical fasteners to the four fastener openings 150 on the mounting straps 146 of the wall electrical receptacle 134A (for example, see FIG. 49). The illustrated body 14 is secured directly to the wall electrical outlet 134A with the two mechanical fasteners but it is noted that the body 14 can alternatively be directly secured to the wall electrical outlet 134A with any other quantity of mechanical fasteners and/or in any other suitable manner.

FIGS. 48 and 49 illustrate a charging station 10 for a portable electronic device 12 according to an ninth embodiment of the present invention. This embodiment further illustrates that the base 14 can take other forms. This embodiment is substantially the same as the first and other embodiments except that it is modified to have two attachment locations 46 which hold two portable electronic devices 12, to be secured directly to a standard wall electrical outlet or receptacle 134A (see FIG. 45), and to have a two-part body 14 which hides the wall electrical outlet 134A from view. This embodiment also enables the base 14 to be easily molded of a suitable polymeric material in order to reduce cost. The illustrated front wall 16 has two openings 50 for removably securing suction cups 48 to the front wall and bottom supports 106 located below the opening 50. The illustrated base 14 replaces the mounting flanges 28 with a rear wall 160 and a separate attachment cover plate 136A that cooperate to secure the body 14 directly to the standard wall electrical receptacle 134A in place of a standard cover plate that typically covers the standard wall electrical receptacle 134A. The illustrated rear wall extends entirely between the side walls, 20, 22 and has a clamping opening 162 therein sized to surround the wall electrical outlet 134A (with its standard cover plate removed).

The attachment cover plate 136A is formed as a separate component from the base 14 and is sized larger than the clamping opening 162 so that when the attachment cover plate 136A is rigidly secured directly to the wall electrical outlet 136A, the rear wall 160 of the body 14 is clamped therebetween and thus rigidly secures the body 14 to the wall electrical outlet 136A and the wall. Just like the integral attachment cover plates 136 described above, the separate attachment cover plate 136A includes at least one outlet opening 138 for the passage of an electrical plug to the wall electrical receptacle 134A and at least one fastener opening 140 for a mechanical fastener to rigidly secure the attachment cover plate 136A to the wall electrical receptacle 134A. The illustrated clamping opening 162 is provided with a flange 164 surrounding the opening 162 that forms a seat for the attachment cover plate 136A which provides abutments that prevent movement of the body 14 relative to the attachment cover plate 136A in each direction (left, right, up and down) when the body 14 is clamped between the attachment cover plate 136A and the wall electrical outlet 134A. The illustrated attachment cover plate 136A is adapted for attachment to a standard GFCI North American electrical outlet 134A and has a single rectangular-shaped outlet opening 138, a pair of fastener openings 140 located at opposed upper and lower ends of the outlet opening 138 for cooperation with mounting openings 158 of the wall electrical receptacle 134A, and four additional fastener openings 152 in a rectangular pattern, with two located above the outlet opening 138 and two located below the outlet opening 138, for passage of mechanical fasteners to the four fastener openings 150 on the mounting straps 146 of the wall electrical receptacle 134A. It is noted that the attachment cover plate 136A can alternatively be adapted to be secured to any other suitable type of wall electrical receptacle 134, 134A. The illustrated body 14 is secured directly to the all electrical outlet 136A with the six mechanical fasteners but it is noted that the body 14 can alternatively be directly secured to the wall electrical outlet with any other quantity of mechanical fasteners and or in any other suitable manner.

It should be appreciated that a kit can be provided that has a single body 14 and two or more separate attachment wall plates 136, 136A which are adapted for attachment to different types of wall electrical outlets 134, 134A (such as for example, standard Type B North American wall electrical outlets and standard GFCI North American electrical outlets). Such a kit would enable a user to easily and cost effectively attach the body 14 to a variety of different types of wall electrical outlets 134, 134A without requiring more than one body 14.

The illustrated body 14 is formed by separate front and rear portions 14A, 14B to provide access to the attachment cover plate 136A for attachment and removal of the body 14 to the wall outlet receptacle 136A. The illustrated front portion 14A is pivotably connected to the rear portion 14B by a pair of hinges 166 located at a bottom of the front wall 16 so that the front portion 14A can by selectively pivoted frontwardly and downwardly relative to the rear portion 14B to an open position that provides access to the attachment cover plate 136A and the interior space 66 and selectively pivoted rearwardly and upwardly relative to the rear portion 14B to a closed position that closes access to the attachment cover plate 136A and the interior space 66. The front and rear portions 14A, 14B are provided with cooperating flexible tabs and openings 168, 170 to removably secure the front portion 14A to the rear position 14B in the closed position. It is noted that any other suitable type of releasable fastening means can alternatively be utilized to releasably connect the front portion 14A to the rear portion 14B of the body 14. It is also noted that the body 14 portions 14A, 14B can alternatively be hinged in other suitable manner such as, for example, hinged for upward opening or hinged for sideways opening or can alternatively not be hinged so that the portions 14A, 14B are entirely removably attached together.

Any of the features or attributes of the above the above described embodiments and variations can be used in combination with any of the other features and attributes of the above described embodiments and variations as desired.

It is apparent from the above detailed description of preferred embodiments of the present invention, that the charging stations 10 improve visibility and usability of the personal electronic devices during charging. Thus, these charging stations 10 will allow easy viewing of streaming videos and the like on the portable electronic devices 12 while not depleting the battery. This is particularly important with the migration of television, movies, and other videos to tablet computers. The charging stations 10 fulfill the need to secure tablet computers on the wall or a desktop for viewing. The charging stations 10 also make it convenient for individuals to use and charge their phone on their night stand next to their bed. Thus, their cell phones can be used as an alarm clock and a replacement for their land line. Additionally, the charging stations 10 organize and hold other objects that do not need to be charged such as mail 130, keys 132, wallets and the like to avoid clutter and misplacement of the items. Furthermore, the charging stations 10 provide better wire management and control than products in the prior art. Moreover, some of the disclosed charging stations 10 can be both mounted to a wall and supported on a table top so the user can select which way they desire to use the charging station 10.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A charging station for a portable electronic device, said charging station comprising, in combination:
a base having a substantially vertical and forward facing wall;
at least one forward facing fastener on the forward facing wall so that the fastener can temporarily secure the portable electronic device to the forward facing wall in a position that the portable electronic device can be viewed and operated while recharging;
wherein the base has an attachment cover plate for securing the base directly to a wall electrical receptacle; and
wherein the attachment cover plate includes at least one outlet opening and at least one fastener opening.

2. The charging station according to claim 1, wherein the attachment cover plate is adapted to be secured to a standard Type B North American electrical outlet.

3. The charging station according to claim 1, wherein the attachment cover plate is adapted to be secured to a standard GFCI North American electrical outlet.

4. The charging station according to claim 1, wherein there is only one fastener secured to the forward facing wall.

5. The charging station according to claim 1, wherein the fastener is removable from the forward facing wall.

6. The charging station according to claim 1, further comprising a cradle located below the fastener to limit downward movement of the portable electronic device.

7. The charging station according to claim 1, wherein the fastener comprises a suction cup.

8. A charging station for a portable electronic device, said charging station comprising, in combination:
a base having a substantially vertical and forward facing wall;
at least one forward facing fastener on the forward facing wall so that the fastener can temporarily secure the portable electronic device to the forward facing wall in a position that the portable electronic device can be viewed and operated while recharging;
wherein the base has a rear wall with a clamping opening for a wall electrical receptacle therein;
an attachment cover plate for attachment directly to the wall electrical receptacle to clamp the rear wall between the attachment cover plate and the wall electrical receptacle; and
wherein the attachment cover plate and the body are formed as separate components and the attachment cover plate includes at least one outlet opening and at least one fastener opening.

9. The charging station according to claim 8, wherein the attachment cover plate is adapted to be secured to a standard Type B North American electrical outlet.

10. The charging station according to claim 8, wherein the attachment cover plate is adapted to be secured to a standard GFCI North American electrical outlet.

11. The charging station according to claim 8, wherein the body includes front and rear portions hinged together so that the front portion is pivotable relative to the rear portion between a closed position and an open position.

12. The charging station according to claim 8, wherein the fastener is removable from the forward facing wall.

13. The charging station according to claim 8, further comprising a cradle located below the fastener to limit downward movement of the portable electronic device.

14. The charging station according to claim 8, wherein the fastener comprises a suction cup.

15. A charging station for a portable electronic device, said charging station comprising, in combination:
a base having a substantially vertical and forward facing wall;
at least one forward facing fastener on the forward facing wall so that the fastener can temporarily secure the portable electronic device to the forward facing wall in a position that the portable electronic device can be viewed and operated while recharging; and
wherein the body forms a hollow interior and the body includes front and rear portions binged together so that the front portion is pivotable relative to the rear portion between a closed position and an open position.

16. The charging station according to claim 15, further comprising at least one releasable fastener for selectively securing the front portion to the rear portion in the closed position.

17. The charging station according to claim 16, wherein the releasable fastener includes at least one flexible tab and at least one tab opening for cooperating with the flexible tab.

18. The charging station according to claim 15, wherein the fastener is removable from the forward facing wall.

19. The charging station according to claim 15, further comprising a cradle located below the fastener to limit downward movement of the portable electronic device.

20. The charging station according to claim 15, wherein the fastener comprises a suction cup.
